(19) United States
(12) Patent Application Publication
(10) Pub. No.: US 2007/0163124 A1
(43) Pub. Date: Jul. 19, 2007

(54) Cutting blade with replaceable cutting cartridge

(76) Inventor: Mark Kenny, Jensen Beach, FL (US)

Correspondence Address: TANGENT LAW GROUP, 1201 PENNSYLVANIA AVE, NW, SUITE 300, WASHINGTON, DC, 20004, US

(21) Appl. No.: 11/592,121

(22) Filed: Nov. 3, 2006

Related U.S. Application Data
(60) Provisional application No. 60/732,719, filed on Nov. 3, 2005.

(51) Int. Cl. B26B 3/00

(52) U.S. Cl. 30/165

(57) ABSTRACT

The invention includes a cutting blade with replaceable cartridge having a main blade body with an at least one central axis, an at least one receiving section on the main blade body and penetrating through the main blade body. A replaceable cartridge has an at least one sharpened edge thereon and an at least one cartridge tab extending therefrom, the at least one cartridge tabs mating and penetrating and coupling with the at least one receiving section. And a locking mechanism is engaged when the replaceable cartridge is brought into proximity with the main blade body and the at least one receiving section is penetrated and coupled by the at least one cartridge tab.

### CROSS-REFERENCE TO RELATED APPLICATIONS

This application claims the priority of U.S. provisional patent application 60/732,719, filed Nov. 3, 2005, which is incorporated herein by reference.

### BACKGROUND OF THE INVENTION

1. Field of the Invention

The invention relates to a rotary cutting blade with replaceable cutting edge cartridge.

2. Background of the Invention

Cutting blade systems and rotary cutting blades in particular depend on maintaining an efficient cutting surface to operate effectively. This is especially the case in the professional lawn care industry, where rotary lawn mowers, rotary edgers, and similar devices are typically operated for long hours and over assorted terrain to manicure lawns. The blades of such lawn equipment are generally flat elongated piece of steel which are rotationally symmetric on a rotatable shaft. The blades have a sharpened edge on the leading edge of the outer portion of the blade. The outer portion trailing edge, particularly on lawnmowers, is generally slightly raised to cause a fan effect so as to lift the grass and to blow the clippings into a bag or direct the clippings in a desirous manner.

The cutting edge of the blades typically become dull very quickly, from constant use and from contact with obstructions. While the equipment appears to be cutting for a long period of time, in actuality, the cutting edge may have ceased to be a true cutting edge and may thus sever blades of grass only because the mower blade is rotating very fast. Thus, the blades of grass are broken by the spinning blade and are bruised in the process. The grass develops a brown tip because of the bruising, has an unpleasing appearance, and is a damaged plant. Furthermore, since the dull blade must break the grass blades, instead of cutting them, the motor which rotates the blade is under an increased load, thus requiring more maintenance and consuming more fuel.

In the past, the sharpening of these blades required the removal of the entire blade. Once the blade was removed, a new edge could be ground or filed onto the blade. The blade would then have to be remounted onto the shaft. This procedure is very difficult and very time consuming. Moreover, the ground or filed blades are often asymmetric and this asymmetry can cause additional torsional forces on the rotating shaft driving the blade, leading to even more costly repairs to the driving motor.

Various types of replaceable cutters have been proposed to avoid the resharpening and eventual loss of the rotary blade. Such replaceable blades have presented problems of one type or another with regard to the requirement of complex fabrications, strength of the replaceable cutter, weakened resistant to damage by foreign objects, costs, and the like. There has remained a need for a blade with a strong cutter which can be easily replaced at a reasonable cost.

### SUMMARY OF THE INVENTION

An object of the invention is to provide a cost effective, simple solution to maintaining a sharpened blade edge in a cutting tool.

An further object of the invention is to a secure and safe method of affixing a replaceable cartridge with a sharpened cutting edge on a main blade body, the cartridge being easily to remove and reinstall a new cartridge with a new sharpened edge after a period of use and wear on the original.

The invention includes an apparatus and a method for using the apparatus.

The invention includes a cutting blade with replaceable cartridge having a main blade body having an at least one central axis, an at least one receiving section on the main blade body and penetrating through the main blade body, a replaceable cartridge having an at least one sharpened edge thereon and having an at least one cartridge tab extending therefrom, the at least one cartridge tabs mating and penetrating and coupling the at least one receiving section, and a locking mechanism engaged when the replaceable cartridge is brought into proximity with the main blade body and the at least one receiving section is penetrated and coupled by the at least one cartridge tab.

Moreover, the above objects and advantages of the invention are illustrative, and not exhaustive, of those which can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

Embodiments of the invention are explained in greater detail by way of the drawings, where the same reference numerals refer to the same features.

FIG. 1 shows an exploded view of an exemplary embodiment of the instant invention

FIG. 2 shows a side view from the outside edge of the main blade body of the exemplary embodiment of FIG. 1 with the replaceable cartridge attached.

FIG. 3 shows a cross section of the exemplary embodiment of FIG. 1 along line A-A with the replaceable cartridge attached.

### DETAILED DESCRIPTION OF THE INVENTION

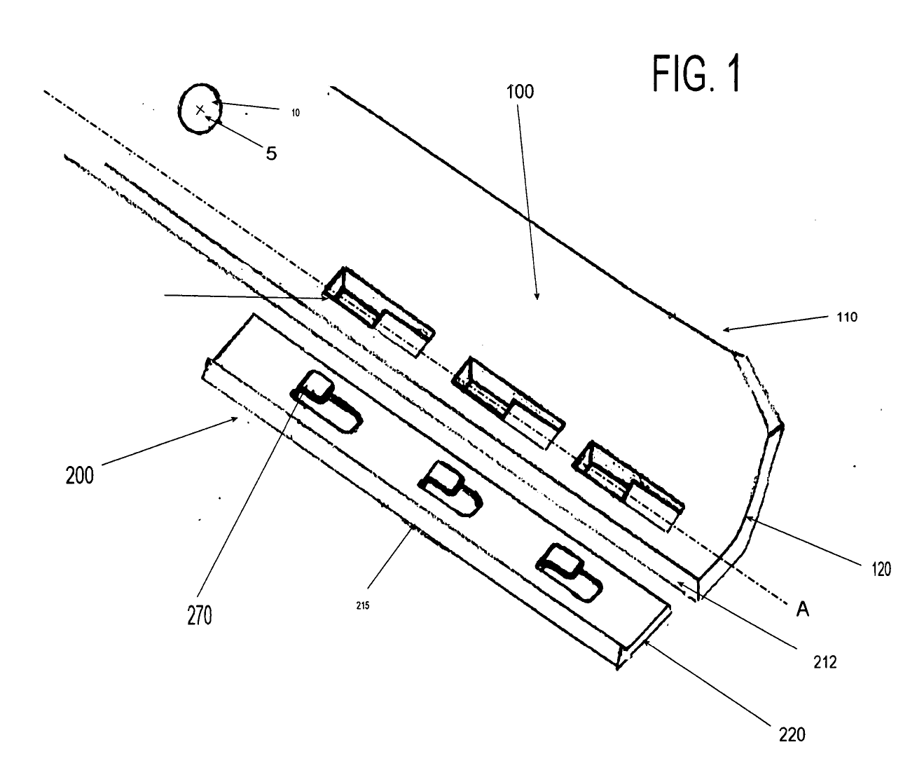

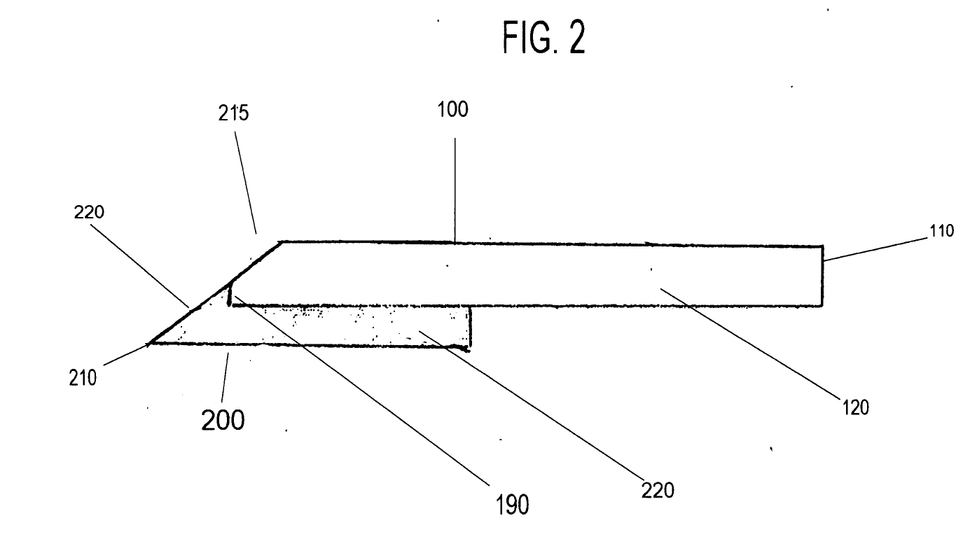

FIG. 1 shows an exploded view of an exemplary embodiment of the instant invention. The instant invention is directed to a cutting blade having a replaceable cutting edge, the cutting edge being located on a replaceable blade cartridge. The blade comprises, in an exemplary embodiment, a main blade body 100 having a center axis 5 and a mounting hole 10 for mounting to a cutting device. The blade body has a trailing edge 110 and an outside edge 120. Within the main blade body 100 there are receiving sections 150. These sections receive the cartridge, as further explained below. The main blade body 100 also has a main blade body cutting edge 215 (as seen best in FIG. 2). The replaceable cartridge body 200 has a corresponding cartridge outside edge 220, cartridge tabs 270, and a cartridge cutting edge 205.

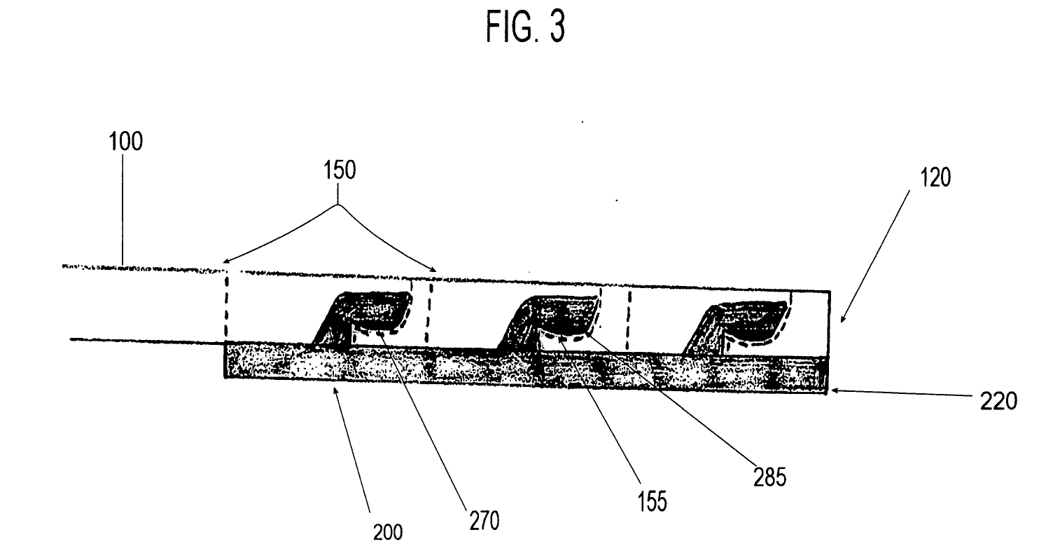

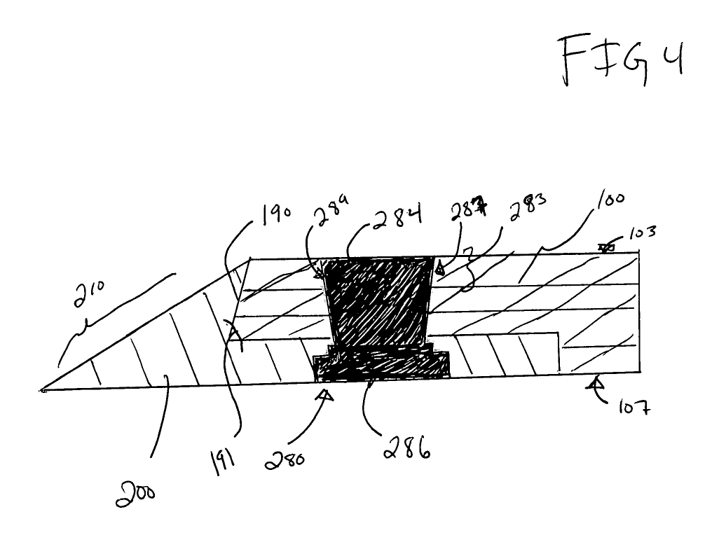

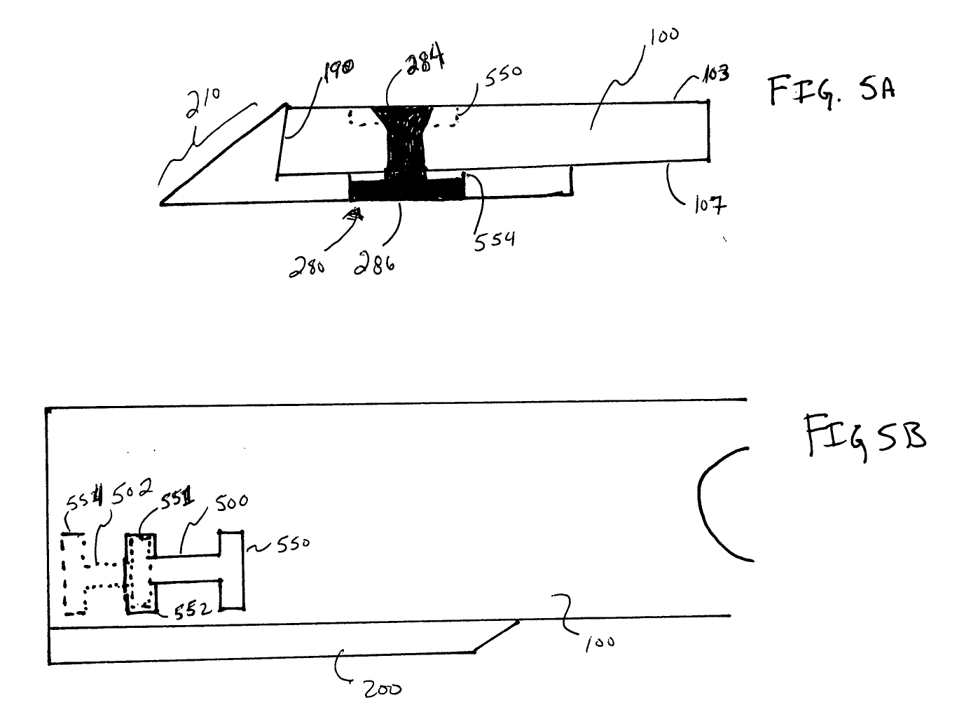

In assembling the blade, the replaceable cartridge 200 is brought to the underside of the main blade body 100. The cartridge tabs 270 are lined up with the receiving sections 150. The cartridge tabs 270 are inserted into the receiving sections 150 and a locking mechanism 280 is engaged to secure the cartridge 200 in place. In the exemplary embodiment shown in FIGS. 1-3 the locking mechanism 280 is a friction fit mechanism provided by a protrusion 285 on the cartridge tab 270 and corresponding detent 180 in receiving section 150 (as best see in FIG. 3). Other locking mechanisms, such as slots, tabs, screws, glue, rivets, bolts and similar locking mechanisms can be provided without departing from the spirit of the invention. Similarly, the tabs 270 and receiving sections 150 can be reversed, so that the tabs protrude from the blade body 100 and the receiving sections 150 can be located in the cartridge 200 without departing from the spirit of the invention.

FIG. 2 shows a side view from the outside edge of the main blade body of the exemplary embodiment of FIG. 1 with the cartridge attached. The main blade body 100 is shown with replaceable cartridge 200 mounted thereto. The cutting edge 210 is comprised of the lead cutting edge 220 on the cartridge body 200 and the main body leading edge 215. In further embodiments, as described herein below, the cutting edge 210 may comprise the entirety of the cutting edge of the blade system. A mounting shoulder 190 is provided to strengthen the support provided by the main blade body 100 to the replaceable cartridge 200. During operation, the centrifugal force of the rotating cutting edge about the center axis 10 further push the replaceable cartridge 200 outwardly and into the friction fit locking mechanism 280 as provided. Additionally, the mounting shoulder 190 stiffens the cutting blade and provides additional support to the combination during operation and during any possible impact with obstructions.

FIG. 3 shows a cross section of the exemplary embodiment of FIG. 1 along line A-A with the replacement cartridge attached. The figure shows the main blade body 100 with the replaceable cartridge 200 mounted thereon. Cartridge tabs 270 are inserted into receiving section 150. The cartridge tabs 270 are part of the locking mechanism 280. A bulbous protrusion 285 extends from the surface of each of the cartridge tabs 270 that mates with the receiving section 150. The receiving section 150 has a corresponding detent 155 which mates with the bulbous protrusion 285. The two corresponding parts combine to form a friction fit locking mechanism, as bulbous protrusion 285 is forced over the portion of the receiving section 150 without the detent 155. Alternative locking mechanisms can include but are certainly not limited to other shapes and components forming a friction lock, posts, rivets, screws, bolts, and similar securing mechanisms, and other locking mechanisms.

In a further exemplary embodiment of the instant invention, a detent 305 is provided on the underside of main blade body 100. The detent may be machined or coined into the main blade body 100. The detent 305 is similar in size to the cartridge 200, but slightly longer to accommodate the movement of the cartridge 200 during installation. The detent 305 allows for the cartridge 200 to be mounted flush to the main blade body 100.

FIG. 4 shows an additional cross section of another embodiment of the present invention. A main blade body 100 is shown with an upper blade surface 103 and a lower blade surface 107. A replaceable cartridge 200 is slidingly coupled to the main blade body 100. The replaceable cartridge 200 is engaged by a mounting shoulder 190. The mounting shoulder 190 is shown with a rake angle 191. The rake angle 191 is between about 0 and 45 degrees. The rake angle 191 within the mounting shoulder 190 significantly strengthens the operative connection of the replaceable cartridge 200 with the main blade body 100, such that an impact will drive the replaceable cartridge 200 back into the main blade body 100. Additionally, the locking mechanism 280, here a rivet, is shown here as having a recess 283, cut with angles 287,289, so that the locking mechanism 280 has an upper portion 284 that is flush with upper surface 103 of the main blade body 100. This aids in keeping the upper parts of the locking mechanism 280 from deteriorating due to wear. Additionally, the locking mechanism 280 also has a lower portion 286, which is similarly configured to be flush with a lower surface of the replaceable cartridge 200. In the exemplary embodiment shown in FIG. 4 this is shown as, though is certainly not limited to, a recess in the lower surface of the replaceable cartridge 200 to accommodate the lower portion 286 of the locking mechanism 280.

FIGS. 5A and 5B show a further cross section and top down view of another exemplary embodiment of the instant invention. In this embodiment the main blade body 100 is provided with a replaceable cartridge 200 having a cutting edge 210 and a mounting shoulder 190 with a slight rake angle 191 at the point of contact between the main blade body 100 and the mounting shoulder 190, similar to the embodiment shown in FIG. 4. Additionally, a channel 500 is shown cut into the upper surface 103 of the blade body with a similar channel 502 cut into the lower surface 107, aligned longitudinally with and offset from the channel 500 cut in the upper surface 103.

At each end of the channels 500,502, T-slots 550-554 are cut within the ends of the channels 500,502. The T-slots 550-554 are cut perpendicular to the channels 500,502 at each end. The T-slots 550-554, as shown in FIG. 5B, overlap at opposite ends on the channels 500,502 in the upper surface 103 and lower surface 107, respectively. The T-slots 550-554 allow the head of a specially shaped installation tool (not shown) to enter or exit. The tool is shaped to fit in and runs within the channels 500,502. The installation tool (not shown) is admitted through a T-slot (not shown) in the replaceable cartridge 200, penetrates through the replaceable cartridge 200 and into a corresponding T-slot 550-554 at one end of the channel 500 or 502 and drives the replaceable cartridge 200 and the locking mechanism 280 within the channels 500,502 for the length of the channels 500,502. The specially designed tool (not shown) is only capable of being removed once it reaches a pre-defined distance that corresponds to the distance for full installation of the replaceable cartridge 200. Thus, the replaceable cartridge 200 is affirmatively driven by the tool to the proper installation position and friction fit in or mating within the main blade body 100. Similarly the tool (not shown) will need to be inserted, driven, then fully removed by reversing the installation process and aligning the T-slots.

The embodiments and examples discussed herein are non-limiting examples. The invention is described in detail with respect to preferred embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

What is claimed is:

1. An apparatus for cutting as described herein above.

2. A method of operating the apparatus as described herein above.

3. A cutting blade with replaceable cartridge comprising:
a main blade body having an at least one central axis, an at least one receiving section on the main blade body and penetrating through the main blade body;
a replaceable cartridge having an at least one sharpened edge thereon and having an at least one cartridge tab extending therefrom, the at least one cartridge tabs mating and penetrating and coupling the at least one receiving section; and
a locking mechanism engaged when the replaceable cartridge is brought into proximity with the main blade body and the at least one receiving section is penetrated and coupled by the at least one cartridge tab.
